(19) United States
(12) Patent Application Publication
(10) Pub. No.: US 2015/0364096 A1
(43) Pub. Date: Dec. 17, 2015

(54) FLEXIBLE SPLICING DISPLAY APPARATUS

(71) Applicant: SHENZHEN CHINA STAR OPTOELECTRONICS TECHNOLOGY CO., LTD., Shenzhen, Guangdong (CN)

(72) Inventors: Xiaowen LV, Guangdong (CN); Chih-Yu SU, Guangdong (CN)

(21) Appl. No.: 14/387,948

(22) PCT Filed: Jun. 19, 2014
(86) PCT No.: PCT/CN2014/080331

§ 371 Date: Sep. 25, 2014

(30) Foreign Application Priority Data
May 31, 2014 (CN) 201410240649.0

(51) Int. Cl. G09G 3/34; G09G 3/32

(52) U.S. Cl. CPC G09G 3/3413; G09G 3/3266; G09G 3/3275; G09G 2320/0626; G09G 2320/0666; G09G 2320/0673; G09G 2300/0426

(57) ABSTRACT

A flexible splicing display apparatus is described. The flexible splicing display apparatus includes a plurality of flexible display devices. The display region is disposed in a central portion of the flexible display device, and the connection region is disposed in the two display regions. The gamma values and colorimetric values of the connection regions between two display regions is ensured based on the gamma and colorimetric values of the two display regions respectively. The flexible splicing display apparatus of the present invention solves the problems of lower brightness and deviation of colors which occurs in the overlapped regions of the OLED flexible display devices.

### FIELD OF THE INVENTION

The present invention relates to a display technique, and more particularly to a flexible splicing display apparatus.

### BACKGROUND OF THE INVENTION

With the technical development and better living standards, people would definitely have increasingly high expectations in terms of liquid crystal display (LCD). To satisfy the large LCD demands of some people and the requirement of some promotional event activities, a few of conventional LCDs are spliced and merged to form a large size display apparatus composed of the LCDs.

In the prior art, the manners of splicing the LCDs to form the larger display apparatus include:

For the first way, a plurality of individual LCDs are spliced into a merged TV wall. A display signal is inputted to the merged TV wall for the larger display manner However, each of the individual LCDs in the merged TV wall has itself frame bezel, resulting in the discontinuous display screen which occurs in the frame bezels of each individual LCD in the merged TV wall and downgrades the display quality.

For the second way, a plurality of organic light-emitting diode (OLED) flexible display devices are spliced to form the TV wall. Since the each of the OLED flexible display devices of the TV wall overlaps adjacently, the discontinuous display screen which occurs in the frame bezels of each OLED flexible display devices is decreased. However, the issues of lower brightness and deviation of colors occurs in the overlapped regions of the OLED flexible display devices.

Consequently, there is a need to develop a novel of flexible splicing display apparatus to solve the aforementioned issues.

### SUMMARY OF THE INVENTION

One objective of the present invention is to provide a flexible splicing display apparatus of the present invention to solve the problems of lower brightness and deviation of colors which occurs in the overlapped regions of the OLED flexible display devices.

According to the above objective, the present invention sets forth a flexible splicing display apparatus. The flexible splicing display apparatus having a plurality of flexible display devices, each of the flexible display devices comprising:
a display region, disposed in a central portion of the flexible display device for displaying the image screen correspondingly; and
a connection region, disposed in the two display regions;
wherein the connection region is formed by overlapping two edge portions of two flexible display devices;
wherein the connection region comprises: a first connection, being adjacent to the first display region near the connection region; a second connection region, being adjacent to the second display region near the connection region; wherein the a size of the first connection region is the same as a size of the second connection region, and the connection region is disposed between the first display region and the second display region; wherein a gamma value of the first connection region is the same as a gamma value of the first display region, and a gamma value of the second connection region is the same as a gamma value of the second display region; wherein a color hue value of the first connection region is the same as a color hue value of the first display region, and a color hue value of the second connection region is the same as a color hue value of the second display region; wherein the gamma value of the connection region is set by adjusting the gamma value of the connection region near at least one edge portion of the flexible display device; and wherein the color hue value of the connection region is set by adjusting the color hue value of the connection region near at least one edge portion of the flexible display device.

In one embodiment, the flexible display device further comprises: a plurality of pixel units, formed by a plurality of data lines and a plurality of scan lines wherein data signals are transmitted to the pixel units correspondingly, and scan signals are transmitted to the pixel units correspondingly; a driving chip for generating the data signals and the scan signals; a plurality of data signal wires for sending the data signals to the data lines correspondingly; and a plurality of scan signal wires for sending the scan signals to the scan lines correspondingly; wherein the data signal wires of the flexible display device and the data lines are connected correspondingly within the display region of the flexible display device, and the scan signal wires and the scan lines are connected correspondingly in one side of the driving chip of the flexible display device.

In one embodiment, the data signal wires of the flexible display device are led into the driving chip to be connected to the data lines.

In one embodiment, the data signal wires and the scan signal wires are interlaced to be from the driving chip.

In one embodiment, the flexible display device further comprises: a plurality of pixel units, formed by a plurality of data lines and a plurality of scan lines wherein data signals are transmitted to the pixel units correspondingly, and scan signals are transmitted to the pixel units correspondingly; a driving chip for generating the data signals and the scan signals; a plurality of data signal wires for sending the data signals to the data lines correspondingly; and a plurality of scan signal wires for sending the scan signals to the scan lines correspondingly; wherein the scan signal wires of the flexible display device and the scan lines are connected correspondingly within the display region of the flexible display device, and the data signal wires and the data lines are connected correspondingly in one side of the driving chip of the flexible display device.

In one embodiment, the scan signal wires of the flexible display device are led into the driving chip to be connected to the scan lines.

In one embodiment, the data signal wires and the scan signal wires are interlaced to be from the driving chip.

In one embodiment, a flexible splicing display apparatus having a plurality of flexible display devices, each of the flexible display devices comprising:
a display region, disposed in a central portion of the flexible display device for displaying the image screen correspondingly; and
a connection region, disposed in the two display regions;
wherein the connection region is formed by overlapping two edge portions of two flexible display devices;
wherein the gamma values of the connection regions between two display regions is ensured based on the gamma values of the two display regions respectively, and the colorimetric values of the connection regions between two display regions is ensured based on the colorimetric values of the two display regions respectively.

In one embodiment, the connection region comprises:
a first connection, being adjacent to the first display region near the connection region;
a second connection region, being adjacent to the second display region near the connection region;
wherein the connection region is disposed between the first display region and the second display region;
wherein a gamma value of the first connection region is the same as a gamma value of the first display region, and a gamma value of the second connection region is the same as a gamma value of the second display region;
wherein a color hue value of the first connection region is the same as a color hue value of the first display region, and a color hue value of the second connection region is the same as a color hue value of the second display region;

In one embodiment, the a size of the first connection region is the same as a size of the second connection region.

In one embodiment, the gamma value of the connection region is set by adjusting the gamma value of the connection region near at least one edge portion of the flexible display device.

In one embodiment, the color hue value of the connection region is set by adjusting the color hue value of the connection region near at least one edge portion of the flexible display device.

In one embodiment, the flexible display device further comprises:
a plurality of pixel units, formed by a plurality of data lines and a plurality of scan lines wherein data signals are transmitted to the pixel units correspondingly, and scan signals are transmitted to the pixel units correspondingly;
a driving chip for generating the data signals and the scan signals;
a plurality of data signal wires for sending the data signals to the data lines correspondingly; and
a plurality of scan signal wires for sending the scan signals to the scan lines correspondingly;
wherein the data signal wires of the flexible display device and the data lines are connected correspondingly within the display region of the flexible display device, and the scan signal wires and the scan lines are connected correspondingly in one side of the driving chip of the flexible display device.

In one embodiment, the data signal wires of the flexible display device are led into the driving chip to be connected to the data lines.

In one embodiment, the data signal wires and the scan signal wires are interlaced to be from the driving chip.

In one embodiment, the flexible display device further comprises:
a plurality of pixel units, formed by a plurality of data lines and a plurality of scan lines wherein data signals are transmitted to the pixel units correspondingly, and scan signals are transmitted to the pixel units correspondingly;
a driving chip for generating the data signals and the scan signals;
a plurality of data signal wires for sending the data signals to the data lines correspondingly; and
a plurality of scan signal wires for sending the scan signals to the scan lines correspondingly;
wherein the scan signal wires of the flexible display device and the scan lines are connected correspondingly within the display region of the flexible display device, and the data signal wires and the data lines are connected correspondingly in one side of the driving chip of the flexible display device.

In one embodiment, the scan signal wires of the flexible display device are led into the driving chip to be connected to the scan lines.

In one embodiment, the data signal wires and the scan signal wires are interlaced to be from the driving chip.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a structural schematic view of a flexible splicing display apparatus according to one preferred embodiment of the present invention;

FIG. 2 is a cross-sectional view of flexible splicing display apparatus along line A-A′ of FIG. 1 according to one embodiment of the present invention;

FIG. 3 is a structural schematic view of a conventional flexible display devices in the flexible splicing display apparatus;

FIG. 4 is a structural schematic view of a plurality of flexible display devices in the flexible splicing display apparatus according to a first preferred embodiment of the present invention; and

FIG. 5 is a structural schematic view of a plurality of flexible display devices in the flexible splicing display apparatus according to a second preferred embodiment of the present invention.

### DETAILED DESCRIPTION OF THE PREFERRED EMBODIMENTS

The following descriptions of the respective embodiments are specific embodiments capable of being implemented as illustrations of the present invention, with reference to the appended figures. The terms up, down, front, rear, left, right, interior, exterior, side, etcetera are merely directions referring to the appended figures. Therefore, such directions are employed for explaining and understanding the present invention, but are not limitations thereto. In the drawings, similar structures are represented by the same symbols.

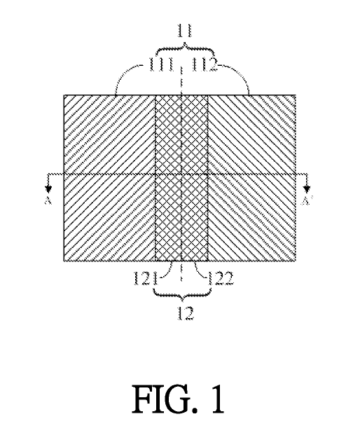

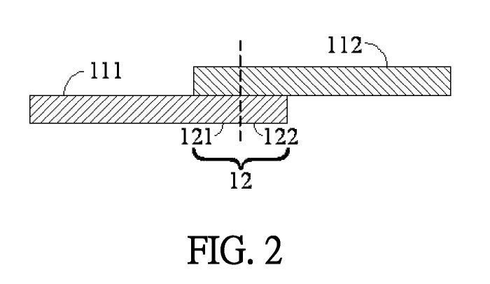

Please refer to . 1 and 2. FIG. 1 is a structural schematic view of a flexible splicing display apparatus according to one preferred embodiment of the present invention. FIG. 2 is a cross-sectional view of flexible splicing display apparatus along line A-A′ of FIG. 1 according to one embodiment of the present invention. In FIG. 1, the flexible splicing display apparatus is composed of a plurality of flexible display devices and comprises display regions 11 and connection regions 12 wherein each of the display regions 11 is disposed in the central portion of the corresponding flexible display device for displaying the image screen and each of the connection regions 12 is disposed in the two adjacent display regions 11.

Specifically, the connection regions 12 is formed by overlapping the edge portions of the adjoining flexible display devices. Thus, the connection regions 12 includes the edge portions of two flexible display devices and one edge portion of one flexible display device is overlaid on the other edge portion of the other one flexible display device.

To improve the display quality in the transitional display region 11 of two flexible display devices, the gamma values of the connection regions 12 between two display regions 11 is detected based on the gamma values of the two display regions 11 respectively in the preferred embodiment of the present invention. The colorimetric values of the connection regions 12 between two display regions 11 is detected based on the colorimetric values of the two display regions 11 respectively. The gamma values represents the either darkness or brightness in the display regions 12 and the colorimetric values represents the color hue and the saturation level in the connection regions 12.

The brightness values and color hue values of the connection regions 12 can be set between the brightness values and color hue values of the adjacent display regions 11. In other words, the brightness values of the connection regions 12 are set between the brightness values of the adjacent display regions 11, and the color hue values of the connection regions 12 are set between the color hue values of the adjacent display regions 11. Such a manner, the deviation of brightness and color hue in the connection region 12 corresponding to two adjacent display regions 11 is prevented from the discontinuous display screen between the display regions 11.

Specifically, each connection region 12 is divided into a first connection region 121 and a second connection region 122. The connection region 12 is disposed between the first display region 111 and the second display region 112. The first connection region 121 is adjacent to the first display region 111 and second connection region 122 is adjacent to the second display region 112. In this manner, the gamma value of the first connection region 121 is set by the gamma value of the first display region 111, and the gamma value of the second connection region 122 is set by the gamma value of the second display region 112. The color hue value of the first connection region 121 is set by the color hue value of the first display region 111, and the color hue value of the second connection region 122 is set by the color hue value of the second display region 112. Therefore, the first display region 111 seamlessly connects to the second display region 112 to prevent the adjacent display regions 11 from the discontinuous display screen.

In another embodiment, the connection region 12 is divided into more than two connecting regions 12 and gamma values and color hue values of the connecting regions 12 are gradually changed. That is, the gamma value of the connecting region 12 which lies closest to the first display region 111 is equal or similar to the gamma value of the first display region 111, and the color hue value of the connecting region 12 which lies closest to the first display region 111 is equal or similar to the color hue value of the first display region 111. The gamma value of the connecting region 12 which lies closest to the second display region 112 is equal or similar to the gamma value of the second display region 112, and the color hue value of the connecting region 12 which lies closest to the second display region 112 is equal or similar to the color hue value of the second display region 112.

In one preferred embodiment, in order to uniform the size of the display regions 11 of the flexible display devices in the flexible splicing display apparatus, the sizes of the first connection region 121 and a second connection region 122 may be identical to improve the display quality of the flexible display devices.

In one embodiment, while the flexible splicing display apparatus displays a image screen, the gamma value of the connection region 12 is set by adjusting the gamma value of the connection region 12 near one edge portion of the flexible display device and/or the gamma value of the connection region 12 is set by adjusting the gamma value of the connection region 12 near two edge portions of the flexible display device. It should be noted that the setting of the gamma value of the connection region 12 depends on the requirement of the designers.

In another embodiment, while the flexible splicing display apparatus displays a image screen, the color hue value of the connection region 12 is set by adjusting the color hue value of the connection region 12 near one edge portion of the flexible display device and/or the color hue value of the connection region 12 is set by adjusting the color hue value of the connection region 12 near two edge portions of the flexible display device. It should be noted that the setting of the color hue value of the connection region 12 depends on the requirement of the designers.

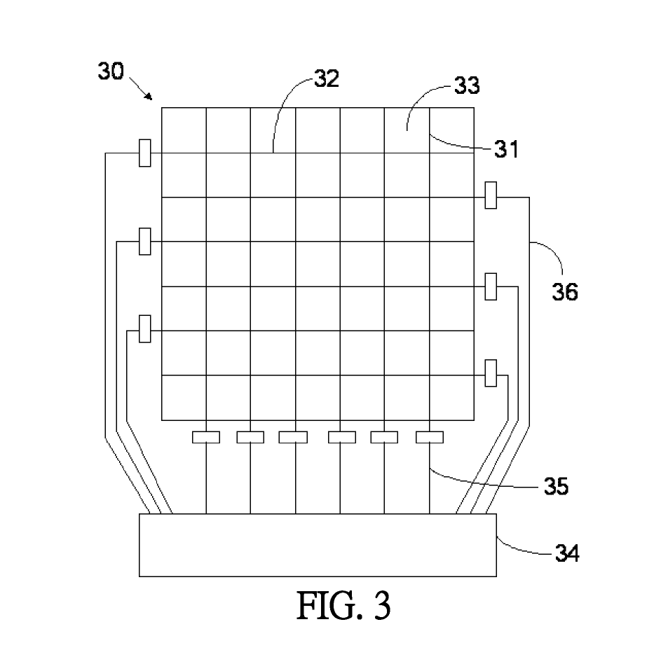

FIG. 3 is a structural schematic view of a conventional flexible display device 30 in the flexible splicing display apparatus. The flexible display device 30 includes data lines 31, scan lines 32 and pixel units 33 composed of interlaced data lines 31 and scan lines 32. The driving chips 34 provides the data signals to the data lines 31 respectively by the data signal wire 35 and provides scan signals to the scan lines 32 respectively by the scan signal wire 36.

In FIG. 3, the connection pads of the data lines 31 and the data signal wire 35 of the flexible display device 30 are disposed in one side of the driving chip 34 of flexible display device 30, and the connection pads of the scan lines 32 and the scan signal wire 36 are disposed in two other sides of the flexible display device 30. Thus, the three sides of the flexible display device 30 includes the connection pads which disadvantageously downgrades the display quality. When the flexible display devices 30 are spliced to form the conventional flexible splicing display apparatus, the side with the connection pads affects the display status of the connection region. As a result, the display quality of the flexible splicing display apparatus composed of the flexible display devices 30 is poor.

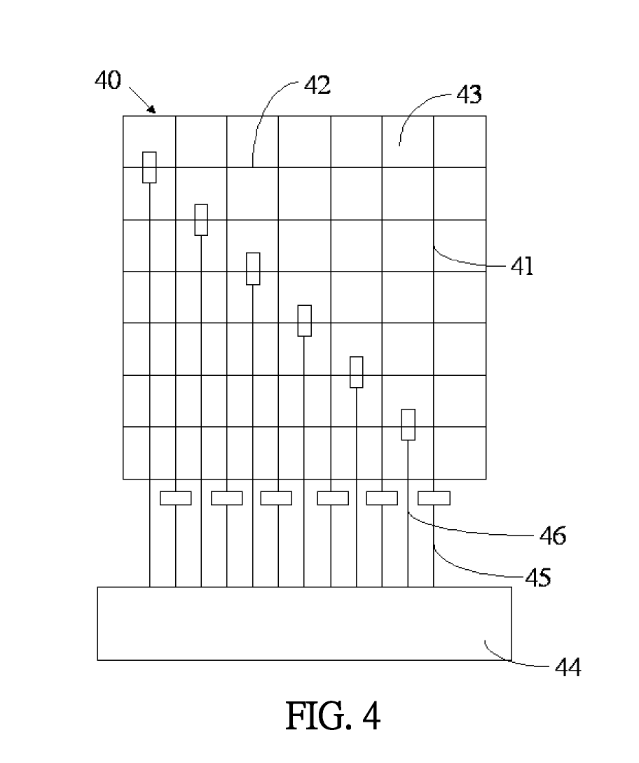

FIG. 4 is a structural schematic view of a plurality of flexible display devices 40 in the flexible splicing display apparatus according to a first preferred embodiment of the present invention. The flexible display device 40 includes pixel units 43, scan lines 42, data lines 41, a driving chip 44, data signal wires 45, scan signal wires 46.

The pixel units 43 are formed by the interlaced scan lines 42 and data lines 41. The data lines 41 transmit the data signal to the pixel units 43 and the scan lines 42 transmit the scan signal to the pixel units 43. The driving chip 44 generates the data signals and scan signal. The data signal wire 45 is used to send the data signal to the data lines 41 correspondingly and the scan signal wire 46 is used to send the scan signal to the scan lines 42 correspondingly.

In one preferred embodiment, the data signal wires 45 of the flexible display device 40 and the data lines 41 are connected correspondingly within the display region of the flexible display device 40. The scan signal wires 46 and the scan lines 42 are connected correspondingly in one side of the driving chip 44 of the flexible display device 40. Further, the data signal wires 45 are connected to the one side of the driving chip 44 of the flexible display device 40. In this manner, the flexible display device 40 advantageously includes one side having the connection pads of the signal wires. Thus, while the flexible display devices 40 are spliced, only one side of flexible display device 40 may affect the spliced status of the flexible splicing display apparatus, which effectively improve the display quality of the flexible splicing display apparatus composed of flexible display devices 40.

In one preferred embodiment, the data signal wires 45 and the scan signal wires 46 of the flexible display device 40 are led from the driving chip 44 so that the data signal wires 45 and the scan signal wire 46 are not intersected to increase the stability of the output signal of the data signals and the scan signals.

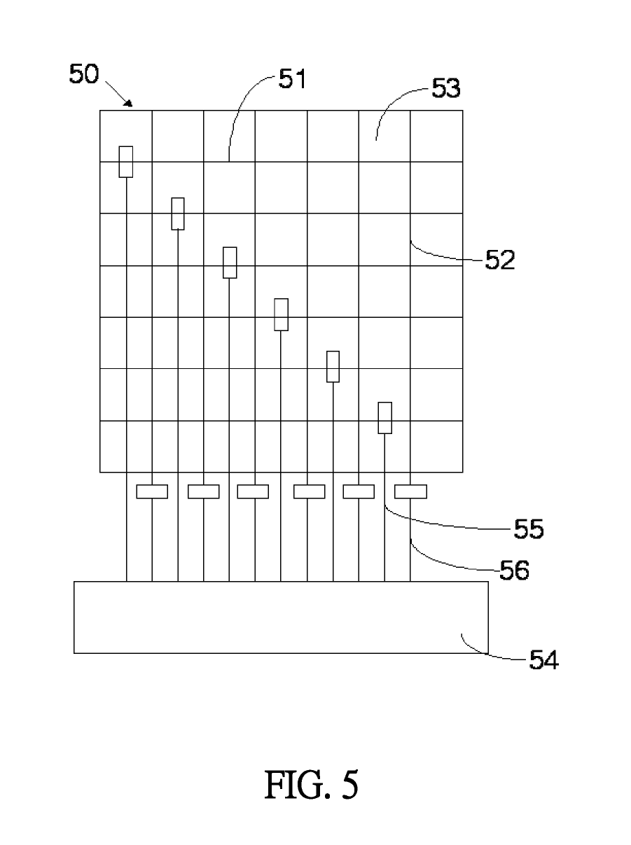

FIG. 5 is a structural schematic view of a plurality of flexible display devices in the flexible splicing display apparatus according to a second preferred embodiment of the present invention. The flexible display device 50 includes pixel units 53, scan lines 52, data lines 51, a driving chip 54, data signal wires 55, scan signal wires 56.

The pixel units 53 are formed by the interlaced scan lines 52 and data lines 51. The data lines 51 transmit the data signal to the pixel units 53 and the scan lines 52 transmit the scan signal to the pixel units 53. The driving chip 54 generates the data signals and scan signal. The data signal wire 55 is used to send the data signal to the data lines 51 correspondingly and the scan signal wire 56 is used to send the scan signal to the scan lines 52 correspondingly.

In one preferred embodiment, the data signal wires 55 of the flexible display device 50 and the data lines 51 are connected correspondingly within the display region of the flexible display device 50. The scan signal wire 56 and the scan lines 52 are connected in one side of the driving chip 54 of the flexible display device 50. Further, the data signal wires 55 are connected to the one side of the driving chip 54 of the flexible display device 50. In this manner, the flexible display device 50 advantageously includes one side having the connection pads of the signal wires. Thus, while the flexible display devices 50 are spliced, only one side of flexible display device 50 may affect the spliced status of the flexible splicing display apparatus, which effectively improve the display quality of the flexible splicing display apparatus composed of flexible display devices 50.

In one preferred embodiment, the data signal wires 55 and the scan signal wire 56 of the flexible display device 50 are led from the driving chip 54 so that the data signal wires 55 and the scan signal wire 56 are not intersected to increase the stability of the output signal of the data signals and the scan signals.

According to the above-mentioned descriptions of the present invention, the gamma values of the connection regions between two display regions is ensured based on the gamma values of the two display regions respectively, which improves the brightness and color hue continuations between two adjacent display regions. Further, the connection pads of the data signal wires and data lines of the flexible display devices of the flexible splicing display apparatus, and/or the connection pads of the scan signal wires and scan lines of the flexible display devices of the flexible splicing display apparatus are disposed in one side to increase the display quality of the flexible splicing display apparatus for solving the problems of lower brightness and deviation of colors which occurs in the overlapped regions of the OLED flexible display devices.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A flexible splicing display apparatus having a plurality of flexible display devices, each of the flexible display devices comprising:
a display region, disposed in a central portion of the flexible display device for displaying the image screen correspondingly; and
a connection region, disposed in the two display regions;
wherein the connection region is formed by overlapping two edge portions of two flexible display devices;
wherein the connection region comprises:
a first connection, being adjacent to the first display region near the connection region;
a second connection region, being adjacent to the second display region near the connection region;
wherein the a size of the first connection region is the same as a size of the second connection region, and the connection region is disposed between the first display region and the second display region;
wherein a gamma value of the first connection region is the same as a gamma value of the first display region, and a gamma value of the second connection region is the same as a gamma value of the second display region;
wherein a color hue value of the first connection region is the same as a color hue value of the first display region, and a color hue value of the second connection region is the same as a color hue value of the second display region;
wherein the gamma value of the connection region is set by adjusting the gamma value of the connection region near at least one edge portion of the flexible display device; and
wherein the color hue value of the connection region is set by adjusting the color hue value of the connection region near at least one edge portion of the flexible display device.

2. The flexible splicing display apparatus of claim 1, wherein the flexible display device further comprises:
a plurality of pixel units, formed by a plurality of data lines and a plurality of scan lines wherein data signals are transmitted to the pixel units correspondingly, and scan signals are transmitted to the pixel units correspondingly;
a driving chip for generating the data signals and the scan signals;
a plurality of data signal wires for sending the data signals to the data lines correspondingly; and
a plurality of scan signal wires for sending the scan signals to the scan lines correspondingly;
wherein the data signal wires of the flexible display device and the data lines are connected correspondingly within the display region of the flexible display device, and the scan signal wires and the scan lines are connected correspondingly in one side of the driving chip of the flexible display device.

3. The flexible splicing display apparatus of claim 2, wherein the data signal wires of the flexible display device are led into the driving chip to be connected to the data lines.

4. The flexible splicing display apparatus of claim 3, wherein the data signal wires and the scan signal wires are interlaced to be from the driving chip.

5. The flexible splicing display apparatus of claim 1, wherein the flexible display device further comprises:
a plurality of pixel units, formed by a plurality of data lines and a plurality of scan lines wherein data signals are transmitted to the pixel units correspondingly, and scan signals are transmitted to the pixel units correspondingly;
a driving chip for generating the data signals and the scan signals;
a plurality of data signal wires for sending the data signals to the data lines correspondingly; and
a plurality of scan signal wires for sending the scan signals to the scan lines correspondingly;
wherein the scan signal wires of the flexible display device and the scan lines are connected correspondingly within the display region of the flexible display device, and the data signal wires and the data lines are connected correspondingly in one side of the driving chip of the flexible display device.

6. The flexible splicing display apparatus of claim 5, wherein the scan signal wires of the flexible display device are led into the driving chip to be connected to the scan lines.

7. The flexible splicing display apparatus of claim 6, wherein the data signal wires and the scan signal wires are interlaced to be from the driving chip.

8. A flexible splicing display apparatus having a plurality of flexible display devices, each of the flexible display devices comprising:
a display region, disposed in a central portion of the flexible display device for displaying the image screen correspondingly; and
a connection region, disposed in the two display regions;
wherein the connection region is formed by overlapping two edge portions of two flexible display devices;
wherein the gamma values of the connection regions between two display regions is ensured based on the gamma values of the two display regions respectively, and the colorimetric values of the connection regions between two display regions is ensured based on the colorimetric values of the two display regions respectively.

9. The flexible splicing display apparatus of claim 8, wherein the connection region comprises:
a first connection, being adjacent to the first display region near the connection region;
a second connection region, being adjacent to the second display region near the connection region;
wherein the connection region is disposed between the first display region and the second display region;
wherein a gamma value of the first connection region is the same as a gamma value of the first display region, and a gamma value of the second connection region is the same as a gamma value of the second display region;
wherein a color hue value of the first connection region is the same as a color hue value of the first display region, and a color hue value of the second connection region is the same as a color hue value of the second display region.

10. The flexible splicing display apparatus of claim 9, wherein the a size of the first connection region is the same as a size of the second connection region.

11. The flexible splicing display apparatus of claim 9, wherein the gamma value of the connection region is set by adjusting the gamma value of the connection region near at least one edge portion of the flexible display device.

12. The flexible splicing display apparatus of claim 9, wherein the color hue value of the connection region is set by adjusting the color hue value of the connection region near at least one edge portion of the flexible display device.

13. The flexible splicing display apparatus of claim 8, wherein the flexible display device further comprises:
a plurality of pixel units, formed by a plurality of data lines and a plurality of scan lines wherein data signals are transmitted to the pixel units correspondingly, and scan signals are transmitted to the pixel units correspondingly;
a driving chip for generating the data signals and the scan signals;
a plurality of data signal wires for sending the data signals to the data lines correspondingly; and
a plurality of scan signal wires for sending the scan signals to the scan lines correspondingly;
wherein the data signal wires of the flexible display device and the data lines are connected correspondingly within the display region of the flexible display device, and the scan signal wires and the scan lines are connected correspondingly in one side of the driving chip of the flexible display device.

14. The flexible splicing display apparatus of claim 13, wherein the data signal wires of the flexible display device are led into the driving chip to be connected to the data lines.

15. The flexible splicing display apparatus of claim 14, wherein the data signal wires and the scan signal wires are interlaced to be from the driving chip.

16. The flexible splicing display apparatus of claim 8, wherein the flexible display device further comprises:
a plurality of pixel units, formed by a plurality of data lines and a plurality of scan lines wherein data signals are transmitted to the pixel units correspondingly, and scan signals are transmitted to the pixel units correspondingly;
a driving chip for generating the data signals and the scan signals;
a plurality of data signal wires for sending the data signals to the data lines correspondingly; and
a plurality of scan signal wires for sending the scan signals to the scan lines correspondingly;
wherein the scan signal wires of the flexible display device and the scan lines are connected correspondingly within the display region of the flexible display device, and the data signal wires and the data lines are connected correspondingly in one side of the driving chip of the flexible display device.

17. The flexible splicing display apparatus of claim 16, wherein the scan signal wires of the flexible display device are led into the driving chip to be connected to the scan lines.

18. The flexible splicing display apparatus of claim 17, wherein the data signal wires and the scan signal wires are interlaced to be from the driving chip.
